(19) United States
(12) Patent Application Publication
(10) Pub. No.: US 2004/0152487 A1
(43) Pub. Date: Aug. 5, 2004

(54) Wireless game control device with audio video signal transmitting and receiving functions

(75) Inventor: Chi-Fu Peng, Taoyuan Hsien (TW)

Correspondence Address: BACON & THOMAS, PLLC, 625 SLATERS LANE, FOURTH FLOOR, ALEXANDRIA, VA, 22314

(73) Assignee: VISION ELECTRONICS CO., LTD., Chungli City (TW)

(21) Appl. No.: 10/358,353

(22) Filed: Feb. 5, 2003

(51) Int. Cl. H04M 1/00; H04B 1/38

(52) U.S. Cl. 455/557; 455/344

(57) ABSTRACT

A wireless game control device for use with a game machine main unit is constructed to include an audio video unit having a speaker and a microphone and a display screen, a communication interface, a control circuit, and a wireless audio video transmitter receiver circuit, the audio video unit communicating with the game machine main unit for transmitting and receiving audio and video signals wirelessly via the wireless audio video transmitter receiver circuit and the communication interface subject to the control of the control circuit so that the user can use the speaker of the audio video unit to receive voice (audio game signal) from the game machine main unit, the microphone to talk to a game partner player when playing an on-line game through the game machine main unit, and the display screen to watch the picture of a game software transmitted from the game machine main unit.

### BACKGROUND OF THE INVENTION

1. Field of the Invention

The present invention relates to game control device for use with a game machine main unit and, more particularly, to a wireless game control device, which transmits audio and video game control signals to the game machine main unit wirelessly and, receives audio and video game signals from the game machine main unit wirelessly.

2. Description of the Related Art

In order to compete with PC games for on-line game, various advanced game machines main systems have been disclosed having the function of playing game software on the Internet. In consequence, diverse peripheral apparatus are developed. For example, on-line game speakers and microphones are used so that players at different places can talk to each other over the Internet while playing an on-line game, making the game more real.

FIG. 1 shows the use of a speaker (earphone/headphone) 11 and a microphone 12 in a game control device 10 according to the prior art. As illustrated, a card bus adapter 14 is used to connect the speaker 11 and the microphone 12 to the card slot 13 of the game control device 10, so that voice signals can be transmitted between the game machine main unit 18 and the speaker 11/microphone 12 through the communication interface 16 of the game control device 10 subject to the control of the control circuit 15. Because the card bus adapter 14 is expensive, it increases the cost of the whole system, resulting in a barrier to the selling of the game system. Further, this card bus adapter 14 cannot be used in a different model of game machine main unit.

FIG. 2 shows another prior art design. According to this design, the game control device 20 comprises a LCD 21 and a speaker 22 respectively connected to the communication interface 24 for communication with the game machine main unit 25 via the control circuit 23. Because the game control device 20 is equipped with a LCD 21, the user can play the game without a monitor. However, because the speaker 22 and the LCD 21 are directly installed in the game control device 20, the whole game control device 20 is bulky and heavy. It is inconvenient to operate this design of game control device 20. The user becomes tired quickly when playing the game control device 20.

Therefore, it is desirable to have a game control device, which eliminates the aforesaid drawbacks.

### SUMMARY OF THE INVENTION

The present invention has been accomplished under the circumstances in view. It is one object of the present invention to provide a game control device, which communicates with the game machine main unit wirelessly. It is another object of the present invention to provide a wireless game control device for use with a game machine main unit, which has the function of transmitting audio and video game control signals to the game machine main unit wirelessly and the function of receiving audio and video game signals from the game machine main unit wirelessly. To achieve these and other objects of the present invention, the wireless game control device comprises an audio video unit having a speaker and a microphone and a display screen, a communication interface, a control circuit, and a wireless audio video transmitter receiver circuit, the audio video unit communicating with the game machine main unit for transmitting and receiving audio and video signals wirelessly via the wireless audio video transmitter receiver circuit and the communication interface subject to the control of the control circuit so that the user can use the speaker of the audio video unit to receive voice (audio game signal) from the game machine main unit, the microphone to talk to a game partner player when playing an on-line game through the game machine main unit, and the display screen to watch the picture of a game software transmitted from the game machine main unit.

### BRIEF DESCRIPTION OF THE DRAWINGS

FIG. 1 is a circuit block diagram of a game system constructed according to the prior art.

FIG. 2 is a circuit block diagram of another design of game system constructed according to the prior art.

FIG. 3 is a circuit block diagram of a game system constructed according to the present invention.

FIG. 4 is a circuit block diagram of an alternate form of the game system constructed according to the present invention.

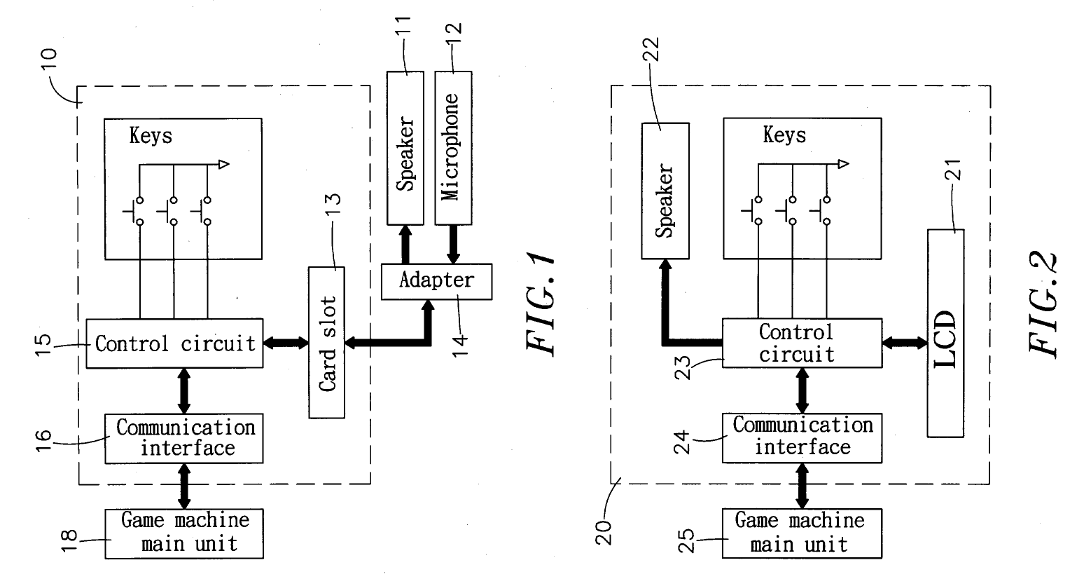

### DETAILED DESCRIPTION OF THE PREFERRED EMBODIMENT

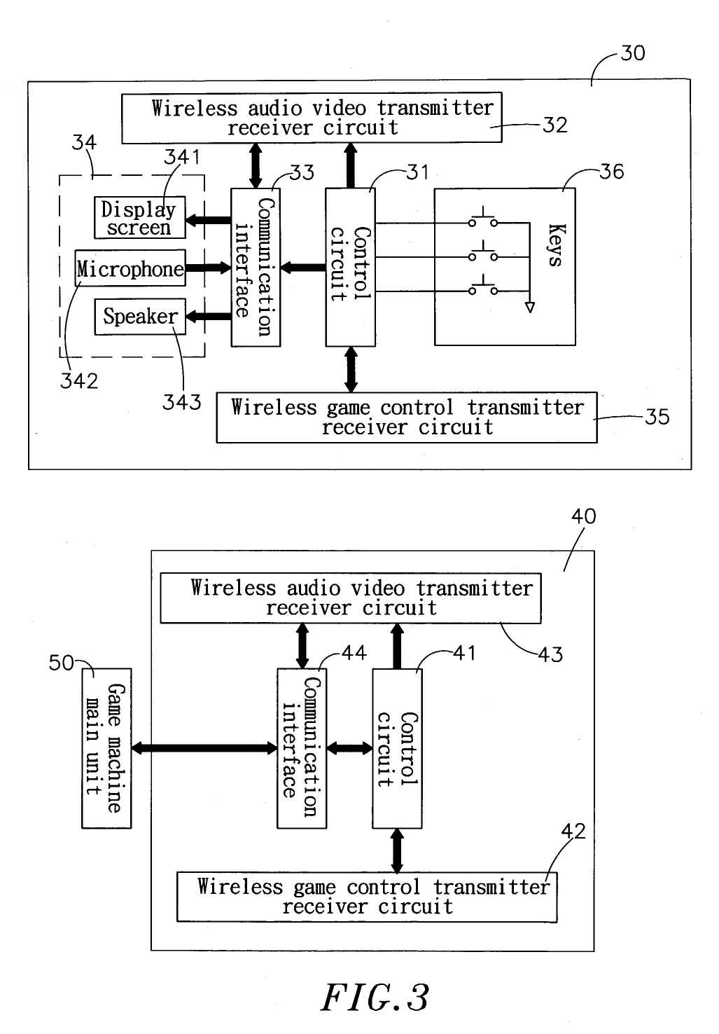

Referring to FIG. 3, a wireless game control device 30 is to be used with a game machine main unit 50 having a wireless terminal device 40 to transmit the audio and video signals of a game software to the game machine main unit 50 wirelessly, or to receive audio and video signals from the game machine main unit 50 wirelessly. The wireless game control device 30 comprises a control circuit 31, a wireless audio video transmitter receiver circuit 32, a communication interface 33, an audio video unit 34, a wireless game control transmitter receiver circuit 35, and a set of keys 36. The wireless audio video transmitter receiver circuit 32, the communication interface 33, and the wireless game control transmitter receiver circuit 35 are respectively connected to the control circuit 31 so that the control circuit 31 controls the operation of the wireless audio video transmitter receiver circuit 32, the communication interface 33, and the wireless game control transmitter receiver circuit 35. The control circuit 31 controls the wireless game control transmitter receiver circuit 35 to communicate with the wireless terminal device 40 of the game machine main unit 50 for transmitting and receiving game control signals wirelessly. The control circuit 31 also controls the wireless audio video transmitter receiver circuit 32 to communicate with the wireless terminal device 40 of the game machine main unit 50 for transmitting and receiving audio and video signals wirelessly. The communication interface 33 enables the audio video unit 34 to communicate with the game machine main unit 50 for transmitting and receiving audio and video signals. The keys 36 are electrically connected to the control circuit 31 for enabling the user to input control signals to drive the game machine main unit 50 to run the game software.

The wireless terminal device 40 is connected to the game machine main unit 50, and adapted to receive signals from the wireless game control device 30 and input received signals to the game machine main unit 50, and to transmit signals from the game machine main unit 50 to the wireless game control device 30 wirelessly. The wireless terminal device 40 comprises a control circuit 41, a wireless game control transmitter receiver circuit 42, a wireless audio video transmitter receiver circuit 43, and a communication interface 44. The wireless game control transmitter receiver circuit 42, the wireless audio video transmitter receiver circuit 43, and the communication interface 44 are respectively connected to the control circuit 41 so that the control circuit 41 controls the operation of the wireless game control transmitter receiver circuit 42, the wireless audio video transmitter receiver circuit 43, and the communication interface 44. The control circuit 41 controls the wireless game control transmitter receiver circuit 42 to let the wireless terminal device 40 transmit game signals to the wireless game control device 30 wirelessly or receive game control signal from the wireless game control device 30 wirelessly. The control circuit 41 also controls the wireless audio video transmitter receiver circuit 43 to let the wireless terminal device 40 transmit audio and video signals to the wireless game control device 30 wirelessly, or to receive audio and video signals from the wireless game control device 30 wirelessly. The communication interface 44 is connected to the game machine main unit 50 to transmit game signals from the game machine main unit 50 to the wireless game control device 30 subject to the user's command, and to transmit game control signals obtained from the wireless game control device 30 to the game machine main unit 50.

Referring to FIG. 3 again, the audio video unit 34 comprises a speaker 343, a microphone 342, and a display screen 341. The user can use the speaker 343 to receive voice (audio game signal) transmitted from the game machine main unit 50, or use the microphone 342 and the speaker 343 to talk to a game partner player when playing an on-line game through the game machine main unit 50, or use the display screen 341 to watch the picture of the game software transmitted from the game machine main unit 50.

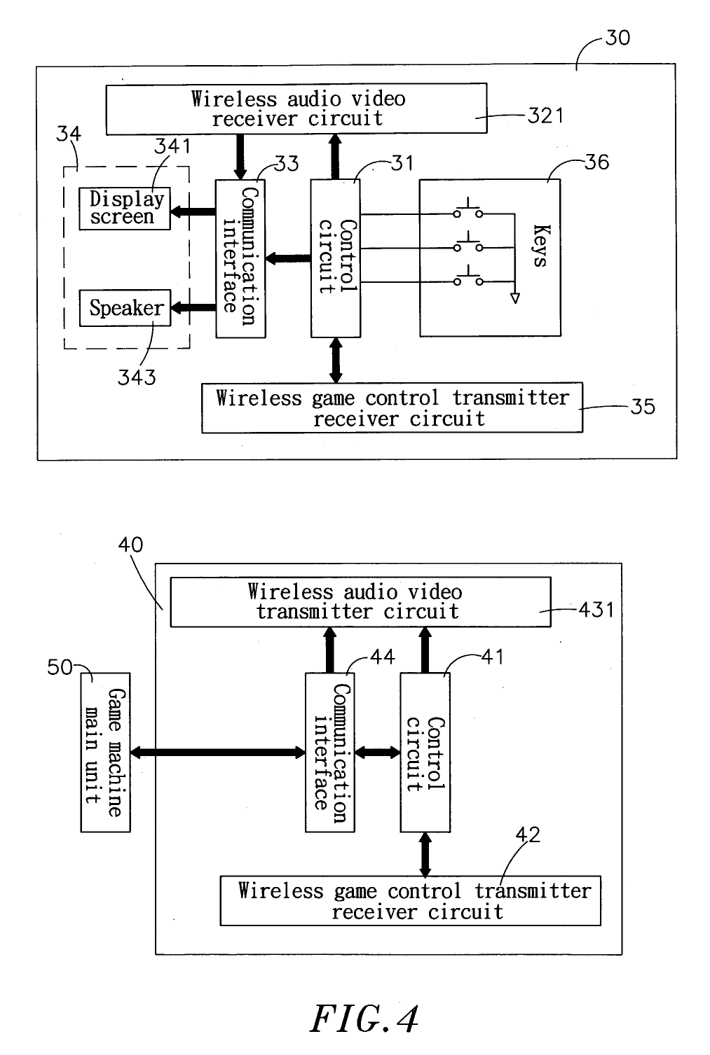

FIG. 4 shows an alternate form of the present invention. According to this embodiment, the wireless game control device 30 is to be used with a game machine main unit 50 having a wireless terminal device 40 to transmit the audio and video signals of a game software to the game machine main unit 50 wirelessly, or to receive audio and video signals from the game machine main unit 50 wirelessly. The wireless game control device 30 comprises a control circuit 31, a wireless audio video receiver circuit 321, a communication interface 33, an audio video unit 34, a wireless game control transmitter receiver circuit 35, and a set of keys 36. The wireless audio video receiver circuit 321, the communication interface 33, and the wireless game control transmitter receiver circuit 35 are respectively connected to the control circuit 31 so that the control circuit 31 controls the operation of the wireless audio video receiver circuit 321, the communication interface 33, and the wireless game control transmitter receiver circuit 35. The control circuit 31 controls the wireless game control transmitter receiver circuit 35 to communicate with the wireless terminal device 40 of the game machine main unit 50 for transmitting game control signals and receiving game signals. The control circuit 31 also controls the wireless audio video receiver circuit 321 to receive audio and video signals from the wireless terminal device 40 of the game machine main unit 50. The communication interface 33 enables the audio video unit 34 to communicate with the game machine main unit 50 for transmitting and receiving audio and video signals. The keys 36 are electrically connected to the control circuit 31 for enabling the user to input control signals to drive the game machine main unit 50 to run the game software.

The wireless terminal device 40 is connected to the game machine main unit 50, and adapted to receive signals from the wireless game control device 30 and input received signals to the game machine main unit 50, and to transmit signals from the game machine main unit 50 to the wireless game control device 30 wirelessly. The wireless terminal device 40 comprises a control circuit 41, a wireless game control transmitter receiver circuit 42, a wireless audio video transmitter circuit 431, and a communication interface 44. The wireless game control transmitter receiver circuit 42, the wireless audio video transmitter circuit 431, and the communication interface 44 are respectively connected to the control circuit 41 so that the control circuit 41 controls the operation of the wireless game control transmitter receiver circuit 42, the wireless audio video transmitter circuit 431, and the communication interface 44. The control circuit 41 controls the wireless game control transmitter receiver circuit 42 to let the wireless terminal device 40 transmit game signals to the wireless game control device 30 wireless, and to receive game control signals from the wireless game control device 30 wirelessly. The control circuit 41 also controls the wireless audio video transmitter circuit 431 to let the wireless terminal device 40 transmit audio and video signals to the wireless game control device 30 wirelessly. The communication interface 44 is connected to the game machine main unit 50 to transmit game signals from the game machine main unit 50 to the wireless game control device 30 subject to the user's command, and to transmit game control signals obtained from the wireless game control device 30 to the game machine main unit 50.

Referring to FIG. 4 again, the audio video unit 34 comprises a speaker 343, and a display screen 341. The user can use the speaker 343 to receive voice (audio game signal) transmitted from the game machine main unit 50, or use display screen 341 to watch the picture of the game software transmitted from the game machine main unit 50.

In the aforesaid two embodiments, the game machine main unit 50 can be a TV game machine main unit, a PC game main unit, or a palm-top game main unit.

A prototype of wireless game control device has been constructed with the features of the annexed drawings of FIGS. 3 and 4. The wireless game control device functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A wireless game control device for use with a game machine main unit having a wireless terminal device to transmit the audio and video signals of a game software to the game machine main unit wirelessly, or to receive audio and video signals from the game machine main unit wirelessly, the wireless game control device comprising:
a control circuit;
a wireless game control transmitter receiver circuit controlled by said control circuit to communicate with the wireless terminal device of the game machine main unit for transmitting and receiving game control signals wirelessly;
a wireless audio video transmitter receiver circuit controlled by said control circuit to communicate with the wireless terminal device of the game machine main unit for transmitting and receiving audio and video signals wirelessly;
an audio video unit;
a communication interface, which enables said audio video unit to transmit audio and video signals to the game machine main unit and to receive audio and video signals from the game machine main unit; and
a set of keys electrically connected to said control circuit for enabling the user to input control signals to drive the game machine main unit to run a game software.

2. The wireless game control device as claimed in claim 1, wherein said audio video unit comprises a speaker for enabling the user to receive voice (audio game signal) transmitted from the game machine main unit, a microphone for enabling the user to talk to a game partner player when playing an on-line game through the game machine main unit, and a display screen for enabling the user to watch the picture of a game software transmitted from the game machine main unit.

3. The wireless game control device as claimed in claim 1, wherein the game machine main unit is a TV game machine main unit.

4. The wireless game control device as claimed in claim 1, wherein the game machine main unit is a PC (personal computer) game main unit.

5. The wireless game control device as claimed in claim 1, wherein the game machine main unit is a palm-top game main unit.

6 A wireless game control device for use with a game machine main unit having a wireless terminal device to transmit the audio and video signals of a game software to the game machine main unit wirelessly, or to receive audio and video signals from the game machine main unit wirelessly, the wireless game control device comprising:
a control circuit;
a wireless game control transmitter receiver circuit controlled by said control circuit to communicate with the wireless terminal device of the game machine main unit for transmitting and receiving game control signals wirelessly;
a wireless audio video transmitter receiver circuit controlled by said control circuit to communicate with the wireless terminal device of the game machine main unit for transmitting and receiving audio and video signals wirelessly; and
a communication interface connected to the game machine main unit and adapted to transmit game signals from the game machine main unit to the wireless game control device, and to transmit game control signals from the wireless game control device to the game machine main unit.

7. A wireless game control device for use with a game machine main unit having a wireless terminal device to receive audio and video signals from the game machine main unit wirelessly, the wireless game control device comprising:
a control circuit;
a wireless game control transmitter receiver circuit controlled by said control circuit to communicate with the wireless terminal device of the game machine main unit for transmitting and receiving game control signals wirelessly;
a wireless audio video receiver circuit controlled by said control circuit to receive audio and video signals from the wireless terminal device of the game machine main unit wirelessly;
an audio video unit;
a communication interface, which enables said audio video unit to receive audio and video signals from the game machine main unit; and
a set of keys electrically connected to said control circuit for enabling the user to input control signals to drive the game machine main unit to run a game software.

8. The wireless game control device as claimed in claim 7, wherein said audio video unit comprises a speaker for enabling the user to receive voice (audio game signal) transmitted from the game machine main unit, and a display screen for enabling the user to watch the picture of a game software transmitted from the game machine main unit.

9. The wireless game control device as claimed in claim 7, wherein the game machine main unit is a TV game machine main unit.

10. The wireless game control device as claimed in claim 7, wherein the game machine main unit is a PC (personal computer) game main unit.

11. The wireless game control device as claimed in claim 7, wherein the game machine main unit is a palm-top game main unit.

12. A wireless game control device for use with a game machine main unit having a wireless terminal device to transmit the audio and video signals of a game software to the game machine main unit wirelessly, or to receive audio and video signals from the game machine main unit wirelessly, the wireless game control device comprising:
a control circuit;
a wireless game control transmitter receiver circuit controlled by said control circuit to communicate with the wireless terminal device of the game machine main unit for transmitting and receiving game control signals wirelessly;
a wireless audio video transmitter circuit controlled by said control circuit to transmit audio and video signals from the wireless terminal device of the game machine main unit to the wireless game control device wirelessly; and
a communication interface connected to the game machine main unit and adapted to transmit game signals from the game machine main unit to the wireless game control device, and to transmit game control signals from the wireless game control device to the game machine main unit.
